(19) United States
(12) Patent Application Publication
(10) Pub. No.: US 2011/0210962 A1
(43) Pub. Date: Sep. 1, 2011

(54) MEDIA RECORDING WITHIN A VIRTUAL WORLD

(75) Inventors: Bernard Horan, Colchester (GB); Paul V. Byrne, Los Altos, CA (US); Douglas C. Twilleager, Campbell, CA (US); Nicole Y. Mordecai, Weston, MA (US)

(73) Assignee: ORACLE INTERNATIONAL CORPORATION, Redwood Shores, CA (US)

(21) Appl. No.: 12/714,671

(22) Filed: Mar. 1, 2010

(51) Int. Cl. G06T 15/00; G06F 3/048; G06T 11/40

(52) U.S. Cl. 345/419; 715/757; 345/552

(57) ABSTRACT

A method for recording media generated within a virtual world from user selectable locations that chosen by a participant of the virtual world without requiring a link with a location of their avatar. The media may be audio or video or still images generated or rendered within the virtual world. The method allows a user to insert independent movie recorders in a virtual world with the cameras associated with such recorders being independent from the avatar and each other. A virtual world generator may include a movie recorder module that allows a participant of the virtual world to insert a movie recorder into the world. The user may also change its position to selectively position a camera on the front portion of the movie recorder body and change the orientation of the movie recorder to allow the user to determine the scene within the world recorded by the camera.

### BACKGROUND

1. Field of the Description

The present description relates, in general, to virtual worlds or massively-multiplayer online games (hereinafter, generally referred to as virtual worlds), and, more particularly, to methods and systems for allowing participants of virtual worlds to more effectively record still and motion/video images and audio (altogether thought of as virtual world “media”) created as part of generating and/or rendering a virtual world, such as via use of one or more user-positionable and selectively operable movie recorders or cameras in a particular virtual world.

2. Relevant Background

Participation in and availability of virtual worlds has been growing rapidly in recent years, and the number of people using virtual worlds has been estimated to be increasing fifteen percent every month with such growth expected to continue into the foreseeable future. Generally, a virtual world is a genre of an online community that takes the form of a computer-based simulated environment through which users or participants can interact with one another and use and create objects. Virtual worlds are also called massively multiplayer online role-playing games (MMORPGs) and massively multiplayer online real-life games (MMORLGs), and the term virtual world is considered to cover both MMORPGs and MMORLGs and other online persistent worlds or smaller online virtual worlds. Virtual worlds are intended for its users to interact and communicate with each other, and virtual worlds typically allow a participant to create a character that is then represented in the virtual world as a three-dimensional (3D) avatar that is visible in the virtual world (e.g., when images of the 3D world are rendered by a computer and its running software and displayed on a monitor).

A participant's client device or computer typically accesses a computer-simulated world and presents perceptual stimuli to the user. The user can operate their client device or computer input/output (I/O) devices to manipulate elements or objects of the modeled world. For example, a user may move their avatar within the virtual world and perform tasks similar to that performed in the real world such as writing on a white board or showing a slide presentation in a meeting or education-based portion of a virtual world or participate in activities such as dancing in a more entertainment-based portion of the virtual world. Communication between users or their avatars has typically included text, graphical icons, visual gestures, and sound. Initial uses of virtual worlds was typically limited to entertainment or social purposes, but, more recently, virtual worlds have been seen as a powerful new media for use in education, business (e.g., training of employees via a virtual world with a training center, virtual meetings of employees that are physically dispersed allowing people to simply access the virtual world to participate in a meeting, and so on), and other settings.

In the context of a 3D virtual world, a user or participant is typically represented in the virtual world in the form of an avatar (e.g., a 3D object or character that acts on behalf of the user). The user interacts with a virtual world by controlling the position of their avatar and by controlling other 3D or 2D objects in the virtual world via computer input devices as a mouse, a keyboard, a touch screen, voice controls, and so on. The user's view of the virtual world is presented to the user via a window provided by the client computer or computing device (e.g., on the screen of a monitor device). The scene of the virtual world visible in the window may be from a choice of several viewpoints. These viewpoints may include: a view as seen from behind the avatar (and, typically, including a depiction of the avatar from behind); a view as seen from the point of view of the avatar (from their “eyes”); and a view as seen from some distance above the avatar taking in the scene of the avatar and its surroundings.

The view provided to the user in the virtual world window is often characterized as being seen via a camera, and the user is able to control the position and orientation of the camera to some degree. For example, some virtual worlds enable a user to control the view of the camera by choosing one of the three points of view of the virtual world described above. In some virtual worlds, a user is able to control the view of the camera via the mouse (e.g., a “mouselook”). Presently, though, the location of the camera is determined relative to the location of the user's avatar. There is a one-to-one relationship between the user's avatar and the corresponding camera. Thus, when the user moves the location of the avatar, the scene captured by the camera is changed, too, which causes what the user can see (and hear) in the virtual world via the computer window to be changed with the location of the avatar.

In some cases, users find it useful to capture images such as video or still images of the virtual world. For example, it may be useful to have a recording of a meeting or class that a user attended in a virtual world for later use. Current mechanisms and techniques for producing an audio-video recording or webcast of a live scene in a virtual world rely on screen grab or screen capture software on the desktop or client computer used by the user to participate in the virtual world. Such screen grab mechanisms capture the contents of a window or the user's desktop along with the audio from the computer and/or the user's microphone into a live stream or computer movie file that can later be replayed using software such as Apple® QuickTime, Microsoft® Windows Media Player, or the like. Hence, the present recording mechanisms for use in virtual worlds are only able to capture the scene as viewed and heard by the user based on the location of their avatar in the virtual world (e.g., based on a present location of the avatar-linked camera).

### SUMMARY

Briefly, a technique is described for recording media generated within a virtual world from one or more locations that are selectable by a participant or user of the virtual world but without requiring a one-to-one link with a location of the participant's avatar. The media may be audio or video or still images generated or rendered within the virtual world (e.g., during running of a virtual world (VW) generator or VW module/system on a computer or computing device). Embodiments may avoid the prior avatar-based recording by providing techniques and/or tools to add multiple independent movie recorders or media recording devices in a virtual world (with the cameras being independent from the avatar and also from each other).

To this end, the VW generator may include a movie recorder module (or media recording module) that allows a user or participant of the VW to insert a movie recorder into the world. The user may also change its position (e.g., its 3D or 2D coordinates or mapping in the world) to selectively position a camera (or lens) on the front portion of the movie recorder body and/or change the orientation of the movie recorder and integral camera so as to allow the user to determine the scene within the world that is captured or recorded by the camera. The movie recorder module may cause the VW generator to display a movie recorder object (e.g., a 3D animated object or element) within the VW at its user-selected location and orientation, and the movie recorder object may be configured to have viewfinder such as on a rear surface of its body. The movie recorder module may operate to provide a small rendering or display of the scene (e.g., media such as video or moving images) that is being captured by the camera in the viewfinder, which causes the movie recorder object to appear in the VW similar to a conventional physical digital camera.

In some embodiments, the movie recorder module is adapted to cause a heads up display (or HUD) to be generated in the VW display or window on a user's monitor or device, and a HUD may be associated with each movie recorder object (or each object's camera). The HUD may provide a small rendering or display of the scene presently being captured (or available for capture/recording) by the associated camera. The HUD may provide the user with camera controls also found on the movie recorder object or additional controls such as zooming, frame rate, scale, and/or other controls provided with physical cameras/movie recorders. The HUD may be operated by a user or participant of the virtual world to position the movie recorder object such that their avatar is in the scene and the rendering of the avatar (or one form of recorded media) may be captured or recorded by the camera. The HUD provides this ability as the viewfinder of the camera would not be displayed to the user in the VW display or window when the avatar is moved to the front of the movie recorder object and the operating camera (similar to the physical or non-virtual world where a person may set up a device to record and then walk into the captured scene).

As noted in the above background, the use of virtual worlds is rapidly expanding from social and entertainment applications to educational and business applications (such as group training meetings, conferences/meetings, collaborative work sessions, and more). The media recording methods and systems taught herein for use in recording media in virtual worlds may provide numerous benefits and advantages over prior avatar position-constrained recording mechanisms. For example, the user is able to use one or more movie recorder objects to record several scenes within a virtual world simultaneously (which may also be webcast or streamed concurrently or at a later time after recording and/or editing/post-recording processing), whereas prior techniques would only support recording images or media from one scene in a virtual world (e.g., using screen grabbing software).

The user is able to record (and/or webcast or stream) a scene in which they are not participating because the recording is not tied to the position of a user's avatar. The user is able to record (and/or webcast or stream) a scene in which their avatar is facing the camera of the movie recorder object whereas prior recording techniques typically would not show the user's avatar and would move with the avatar position rather than allowing the avatar to move freely in front of the camera or within (or in and out of) the captured scene. These and other benefits are made possible because the user is also able to control the location and orientation of the recording of a scene independent of the position of their avatar. The user is also able to record audio local to the scene but not necessarily local to the user's view (avatar's view) of the scene as the audio is recorded based on the position and orientation of the movie recorder object in the virtual world.

More particularly, a method is provided for recording media (e.g., audio, still images, video/moving image, and so on) in a virtual world. The method includes operating a client computer to generate a virtual world in which a user participates via an avatar. The method then includes inserting a movie recorder into the virtual world. In some cases, the movie recorder has a three-dimensional (3D) location in the virtual world that is selectable by the user without reference to a location of the avatar (e.g., the avatar and movie recorder may be moved independent of each other). Then, with the client computer, the method includes receiving input from the user to record a scene of the virtual world with the movie recorder and, in response to the user input, storing rendered images of the scene in data storage (such as a directory for still pictures or for movies).

The method may involve, after the inserting, associating a texture render buffer in memory of the client computer with the movie recorder. Then, the method may further involve rendering frames of the images of the scene, storing the rendered frames of the images in the texture render buffer, and transferring content from the texture render buffer to the data storage during the storing of the rendered images of the scene. In such embodiments, the movie recorder may be a 3D object displayed within the virtual world in a display window of the client computer and the movie recorder 3D object may include a body with a front and rear surface, with the rear surface including a viewfinder displaying the rendered frames in the texture render buffer to display the scene of the virtual world.

In some further embodiments, the media recoding method may include resetting the 3D location of the movie recorder or the location of the avatar such that the avatar is positioned in the scene with the avatar facing the front surface of the body. The front surface may include a camera that is used by the computer (or running movie recorder software) to define a view of the scene of the virtual world for use in recording the scene. In some cases, the method may include operating the client computer to generate a heads up display and displaying the heads up display in display window of the virtual world. The heads up display may include a display portion displaying the rendered frames in the texture render buffer concurrently with the display in the viewfinder. Further, the display portion of the heads up display may be used to display the rendered frames when the movie recorder is oriented by the user such that the front surface of the body is displayed in the display window of the virtual world. In some embodiments, the 3D location of the movie recorder is maintained and the location of the avatar is altered based on input from the user.

Yet further, in some embodiments, the method includes inserting a second movie recorder into the virtual world. The second movie recorder may have an associated texture render buffer provided in memory storing frames of a scene of the virtual world viewable from a camera on the second movie recorder, and the second movie recorder may have a 3D location in the virtual world that is selectable based on user input independent of the 3D location of the movie recorder and the location of the avatar. In some cases, the scene of the virtual world viewable from the camera of the second movie recorder differs from the scene recorded by the movie recorder and the receiving of user recording instructions and the image (or media) storing steps are performed separately for the second movie recorder and for the first movie recorder. In some embodiments, the media recording method also includes storing audio data associated with the scene in the data storage concurrently with the storing of the rendered images, receiving instructions to stop the recording of the scene, and generating a movie file comprising combining the stored rendered images and the stored audio data.

### BRIEF DESCRIPTION OF THE DRAWINGS

FIG. 1 is a functional block diagram of computing system or environment showing hardware and software that may be used to provide a virtual world to client devices or computers using the media recording techniques described herein;

FIG. 2 is a screen shot of a window or display of a virtual world on a client device or computer monitor screen showing a user positioning a movie recorder object in the virtual world independent of a position of an avatar and showing a front side of the movie recorder object;

FIG. 3 is a screen shot of a window or display of the virtual world of FIG. 2 at a different time showing the movie recorder object in a different location or at least orientation showing a viewfinder on a rear surface or side and use of the movie recorder to view and/or capture an image in the virtual world;

FIG. 4 is another screen shot or window of the virtual world of FIGS. 2 and 3 in which a heads up display (HUD) has been requested by the user and generated by the movie recorder module or software showing a display that is a duplicate of a view of a virtual world scene shown in the viewfinder of the movie recorder object; and

FIG. 5 shows a screen shot or window of the virtual world of FIGS. 2-4 showing the movie recorder object in a different position and/or orientation such that it captures a scene and also captures a front view of the user's avatar which, in this case, is not provided on the display (note, this differs from a conventional recording tool as not only would a screen grabber or similar tool not capture a front view of the user's avatar but it would only capture images/media that are displayed in the scene or screen display of the virtual world).

### DETAILED DESCRIPTION

Briefly, the following description is directed to methods and systems for more effectively and flexibly recording media (e.g., audio and rendered still and motion (video) images) within a virtual world. The following description provides an overview of such a media recording method (and system components) and its use to allow a VW participant or user to selectively place one, two, or more movie recorders or movie recorder objects (with associated cameras) in various positions within a virtual world independent of the present or future position of the user's avatar. After this overview, the VW media recording method and system is described in further detail with reference to the included figures that provide examples of computer systems/devices that may be used to implement the method (which is described in part with process flow diagrams) and, additionally, screen shots of exemplary virtual world displays/windows are provided to illustrate use of a movie recorder object with a heads up display (HUD) in a virtual world.

In some embodiments, a movie recorder module (e.g., a software program, code devices, programming object, and so on) is added to or called by a virtual world generator or VW module (which is configured to provide a user via their monitor and their I/O devices a virtual world). The movie recorder module may generate (via the VW module) a 3D object or movie recorder (or movie recorder object) in the virtual world (or VW). The movie recorder may have a 3D body with a front and a rear side. On the front side of the movie recorder, a camera may be positioned facing forwards (e.g., perpendicular to the plane of the front side). The camera may or may not have a physical depiction in the VW, but it acts as the lens or media/data collection point for the movie recorder relative to media generated in the VW (e.g., the camera is used to define a scene in the VW that may be recorded by the movie recorder). On the rear side of the movie recorder, a viewfinder may be provided (e.g., a vertically oriented quadrilateral plane or the like), and the viewfinder may be sized to fit within the bounds of the rear side of the body of the movie recorder. The movie recorder module functions to use the viewfinder to render or display the VW scene as seen or viewed by or through the camera (or lens of the movie recorder).

A HUD may also be associated with each movie recorder positioned by a user in the VW. The HUD may be generated and displayed by the movie recorder module in the VW window or display in response to a user request or input selection of a HUD display for a particular movie recorder. The HUD may include a display area or window that displays what is also being provided to the viewfinder of the movie recorder to show the scene as presently seen or viewed by the camera of the movie recorder, and the HUD may provide the user with additional controls such as selecting to record a scene (or corresponding VW media) with the movie recorder, choosing a directory for storing recorded or captured media (such as audio, stills or snapshots, movies/videos, and so on), zoom or other camera controls, and the like.

In some cases, the VW module may use a render manager to manage the scene for the virtual world. When requested by a user or participant of the world via the VW display or window (or via other I/O), the render manager may communicate with the movie recorder module to provide a movie recorder with a camera, and the camera may be associated with a node in the scene graph of the virtual world (e.g., to define a 3D location of the camera in the virtual world). When the movie recorder is placed in the virtual world, it provides a node that is attached to the virtual world. The camera for the movie recorder is attached to this node of the movie recorder.

When requested by the movie recorder module, the render manager provides a rendering surface known herein as (or associated with) a texture render buffer. A rendering surface may have one camera associated with it, and, in the case of a movie recorder, the movie recorder module requests a texture render buffer from the render manager and associates its camera with that texture render buffer. The render manager manages the rendering of a virtual world scene. In the case of the movie recorder, the texture render buffer is given to the render manager to manage. The viewfinder of the movie recorder is implemented in one embodiment by creating a quadrilateral geometric plane (or quad), and the texture or displayed/rendered image is provided by the texture render buffer. In summary, a texture render buffer has an associated camera. Every time the virtual world scene is rendered by the render manager, the scene seen by the camera is stored in the texture render buffer (or a file within memory associated with the virtual world module), which in turn provides the rendering for the viewfinder (and display of the HUD).

When the movie recorder is operated or told by a user to record (rather than just view a scene and its associated media), additional processing takes place via operation of the movie recorder module (and/or the virtual world module). Every time the scene is rendered, after a record instruction is provided by the user (such as via a record button on the movie recorder in the virtual world), the data in the texture render buffer is saved to a file in JPEG (Joint Photographic Experts Group) format or other desired format. Additionally, the audio from the locality of the movie recorder is saved to a file, e.g., an Au file (audio file format introduced by Sun Microsystems, Inc.) or other audio format file. When the movie recorder module is told or instructed (such as via a user operating the HUD or a user selecting a button on the movie recorder in the virtual world) to stop recording, the individual image files (or JPEG files) are combined into a combined image file (e.g., a Motion-JPEG file or the like) that is in turn combined with the audio file to produce a VW media file for the scene (e.g., a movie or video in Apple's Quicktime format or other movie/video format).

When the movie recorder module is instructed to stream by the user (again, such as via operation of the HUD or, in some cases, a button/controls in virtual world such as on the movie recorder 3D object), similar additional processing may occur. For example, every time the scene is rendered the data in the texture render buffer is saved to a file (e.g., a JPEG file). A stream feed module may be provided that acts to copy this file to a document root of a streaming server (or similar software provided on the user's computer or client device) so that other computer clients may view it as a stream of images, with updating occurring (in some embodiments) every time the virtual world scene is rendered. Instead of recording the audio to a file in such cases, it is transmitted directly to the streaming server in an appropriate format, and the streaming server may act to mix it with the streamed images to give the impression of or provide a combined audio-video webcast from the virtual world.

In some embodiments, the movie recorder may also be operated by the user to take individual images of the virtual world. These images may be thought of as snapshots, stills, or still images of the virtual world or the scene as viewed by the camera of a particular movie recorder. This is performed in response to receiving instructions from the user to take or capture a snapshot such as by pressing a button on the movie recorder object in the virtual world or operating the HUD (a button or other I/O device provided in the HUD). Capturing or recording a still may be achieved in a manner similar to that described for recording a movie except that only one rendered image is recorded each time the user instructs the movie recorder module (via the movie recorder object or HUD) to record. The still may be stored in a still image file for later retrieval, viewing, and other use, and, typically, no audio is recorded and/or associated with the still image.

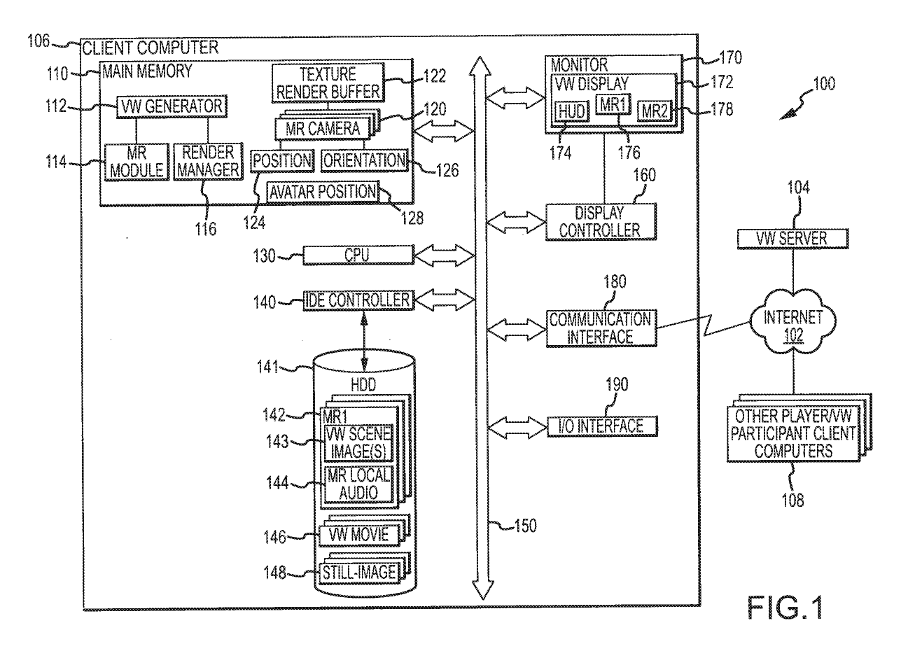

FIG. 1 illustrates a hardware and software configuration of system 100 that may be used to provide virtual world with enhanced media recording capabilities. The system 100 includes a game or VW server 104 that may be accessed via the Internet or other digital communications network 102 in a wired or wireless manner by client computer or device 106 as well as multiple other client computers 108. The client computer 106 (as may devices 108) includes storage devices such as a main memory 110 and a hard disk drive 141. The computer 106 also includes one or more processors as shown with CPU 220 that performs computation processing (e.g., runs or uses code or code devices or software to perform various VW-related functions described herein). The computer or VW-access device 106 may also include an IDE (integrated drive electronics) controller 140 that controls the hard disk drive 141. The computer 106 further includes a display controller 160 that controls a display device or monitor 170 for displaying a virtual world 172, and the computer 106 typically would include one or more graphics cards to support rendering and generating the VW display 172.

The client computer 106 also includes an I/O interface 190 used for input-output of a keyboard, a touch screen, a mouse, and other user I/O devices commonly used for interacting with a VW and/or a computer by user or participant in the virtual world. Additionally, the computer 106 is shown to include a communication interface 280, such as a network interface card. As shown, these various computer devices or components may be communicatively linked via connection to a system bus 150. This configuration is just one example of a client computer 106 and VW system 100, and the client computer 106 is not limited to only or necessarily require all the hardware and software components shown and described. Any software and hardware device having a function as a general personal computer can be used as the client computer 106.

The server computer 104 functions as a virtual world server by executing a program stored in a storage device. The storage device of the server computer 104 may store data indicating the three-dimensional shapes of objects existing in the virtual world later shown in display 172 that may include data called 3D shape model data. In response to a request received from the client computer 106, the server computer 104 may transmit various kinds of information including such data to the client computer 106. The server computer 104 may communicate with multiple client computers 108 via network 102, and, hence, the client computers 106 and 108 share and/or participate in the virtual world.

The client computer 100 displays the virtual world including the 3D shape model data on the display 170 in VW display or window 172 by executing a program stored in the storage device such as the VW generator 112. Once the client computer 106 receives an input from the keyboard, mouse or the like through the I/O interface 190, an avatar representing a user in the virtual world moves in a three dimensional (3D) space according to the received input, with the position 128 of the avatar being tracked by the VW generator 112 and used to define what is displayed in the VW display 172 (e.g., a scene of the VW as viewed by the avatar). Moreover, various events occur in certain circumstances such as when: the avatar acts in a certain way; the user inputs a particular command; and the avatar enters a particular environment in the virtual world. The events occurring with the activities of the avatar are displayed on the display 170 in VW display 172.

It may be useful to tie some of the description of the media recording methods discussed earlier in the overview to this specific example of a computer system 100. As shown, the CPU 130 or other processors may be used to run or execute sets of code to provide the VW recording and streaming described. Specifically, the CPU 130 may run a VW generator 112 to create a virtual world that is presented to the user via display 127 on monitor 170. The VW generator 112 may include or call an MR module 114 that functions to enable a user via I/O interface to insert one or more movie recorders into the virtual world. For example, the user may interact with the VW display 172 to position a first and a second movie recorder 176, 178 in the virtual world shown in display or window 172 through commands provided to the MR module 114. The movie recorders 176, 178 may be positioned independently of the position 128 of the user's avatar and of each other.

The MR module 114 may act to store data including operational settings for each camera associated with these movie recorders 176, 178 as is shown by MR camera files/data 120 in memory 110, and a node or position data 124 is linked to or provided for each camera to map the camera to a 3D position in the virtual world. Also, the user may independently set the orientation 126 for each camera 120 (e.g., two, three, four or more cameras may be positioned in the same location but at differing orientations to capture a scene fully). As discussed above, the VW display 172 may also be operated to provide a HUD 174 for each movie recorder 176, 178 such as via operation of the MR module 114 in response to user input requesting display of the HUD 174 for a particular movie recorder 176, 178.

The VW generator 112 may include or use a render manager 116 to manage the rendering of a scene of the virtual world as provided in display 172. In some cases, the render manager provides the camera 120 associated with a particular node (or position definition) in the scene graph of the virtual world. During operation of the computer 106, the render manager 116 may act to render a scene of the virtual world, and the MR module 114 or render manager 116 may act to store the scene (or VW image data) in a texture render buffer 122 associated with each camera 120 positioned by a user in the VW world via display 172 or using other tools to set a position 124. The MR module 114 or manager 116 may then use this image data or scene data from the texture render buffer 122 to fill a viewfinder in the movie recorders 176, 178 and/or the viewfinder display of a HUD 174 associated with the camera 120.

When the MR module 114 is instructed or commanded to record by the user via I/O interface 190 or the like, the data in the texture render buffer 122 is saved as shown at 143 in a JPEG file or the like in memory/directories 142 (such as in HDD 141 or other data storage/memory). Additionally, the audio from the locality of the movie recorder (such as MR object 176 or 178) is stored or saved to a file 144 or in storage accessible by the client (e.g., non-client-based memory/storage) associated with the movie recorder. Still images 148 may also be captured and stored in memory 141 for the MR object 176, 178 or its associated camera 120. When MR module 114 is instructed by the user to stop recording for a movie recorder (such as MR object 176, 178 in the VW display 172), the JPEG or image files 143 are combined into a combined image file or Motion-JPEG file that is combined with the appropriate audio files 144 to create or produce a movie 146. The movie 146 may then be played in the VW display 172, may be edited or post-recording processed, streamed to other devices or clients, or played in any other display.

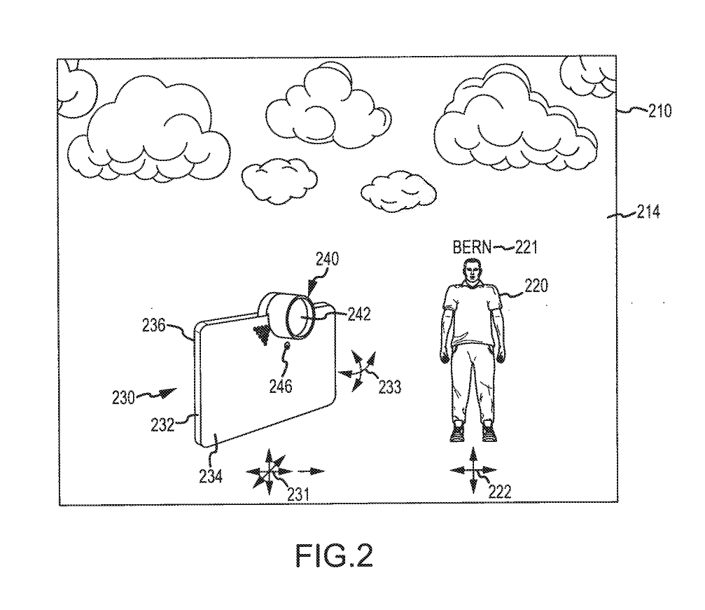

At this point, it may be useful to discuss media recording (such as would be implemented by operation of system 100) with reference to exemplary screen shots of a virtual world and a user's interaction with a movie recorder in the virtual world. FIGS. 2-5 illustrate several simplified, exemplary screen shots of a display or window 210 of a virtual world as may be rendered and/or generated by a VW generator module making use of a movie recorder module and render manager along with a texture render buffer for each movie recorder in the virtual world (as discussed above). The movie recorder module allows a user or participant to place a virtual camera in a 3D scene such as that displayed in VW window 210 with its 3D shapes/elements or scene 214 (e.g., 3D objects simulating physical objects such as the ground, buildings, physical environmental components, and/or nearly any object found in the physical world).

To this end, a user of the virtual world shown in display 210 with scene 214 may have an avatar 220 associated with them that they may move about the virtual world and interact with objects in the scene 214. The user's avatar 220 may be a 3D object and be labeled as shown at 221 (with a user name/ID), and the user may be able to interact with the virtual world to position the avatar as shown with arrows 222. Once the movie recorder is installed and operating, an object window for the virtual world may include a selectable “movie recorder” item or insertable object, and the user may select it and click “insert” or the like to add the object to the world. The user may then use standard editing tools to place a movie recorder 230 within the virtual world shown at 214 in display 210.

Significantly, the user's avatar 220 may be moved or positioned in the world/scene 214 as shown at 222 while the movie recorder 230 is positioned 231 independently of the movement 222 and/or position of avatar 220. This allows the user to position the movie recorder 230 at a location in the scene or world 214 and then move their avatar in front of the movie recorder 220 to be in the recorded images or media or to simply leave the scene (i.e., the avatar 220 does not need to be in the scene 214 for the movie recorder 230 to operate to record audio or still/video images (media) in the virtual world 214). The conventional virtual world editing tools (and I/O devices) allow a user to perform the positioning/locating 231 of the movie recorder 230 irrespective of the avatar 220 position and also allow the user to orient (or point) 233 the movie recorder 230 so as to capture a portion of the scene 214 from a desired direction/angle. In this manner, the user is able to position a movie recorder 230 at any location within the world 214 (and then have a node assigned to the camera 240), e.g., select its 3D position or X-Y-Z position, and also to set it angular orientation (e.g., tip forward or backward some amount such as 45 degrees, pivot sideways in either direction such as 30 degrees, and so on).

The movie recorder 230 may take the form of a conventional or physical digital camera or other design. As shown from the front, the movie recorder 230 includes a body 232 with a front side or surface 234 and a rear side or surface 236, and the body 232 may take a rectangular shape with a relative thin body 232 (but, of course, this is not required as the body shape/design may be altered to practice the invention). The movie recorder 230 includes a camera 240 with a lens 242. From the software or media recording system, the camera 240 acts similar to a conventional camera in that it defines the viewpoint of the movie recorder 230 in the virtual world defining what portions of the scene 214 are captured, and, in some embodiments, the user may operate the camera 240 to zoom in and out, to change frame rates, to change lighting settings, and so on. From the user's perspective, the camera 240 provides a lens 242 that allows the user to also view the portion of the scene that will be recorded (when this operation is selected by the user). The movie recorder 230 may also include an indicator (e.g., a red or other colored light) 246 that is operated by the movie recorder module (or media recording software) to indicate when the camera 240 is recording (e.g., to display a red light when recording otherwise to be dark or an unlit light).

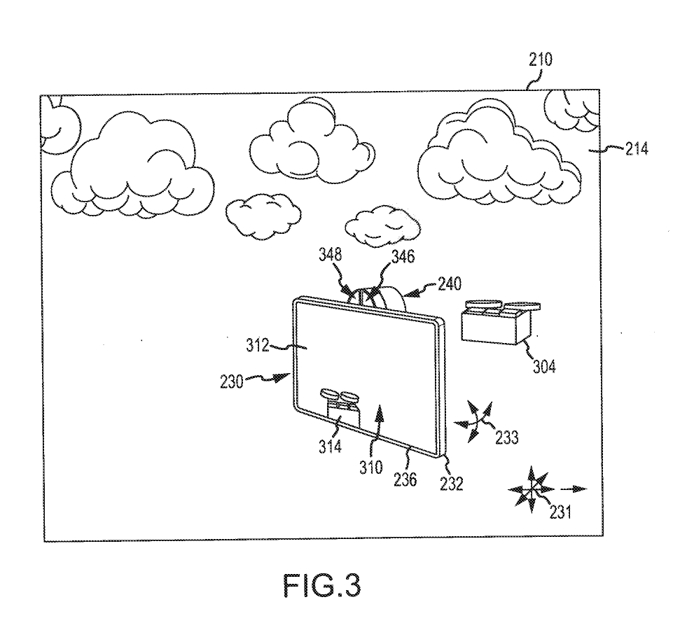

FIG. 3 illustrates the display or window 210 after the user has moved their avatar (not shown in this view) and has repositioned 231 or at least re-oriented 233 the movie recorder 230 to display a different scene 214 (or portion of a virtual world). As shown, the movie recorder 230 can be seen from the rear with rear side or surface 236 facing outward toward a viewer of the display 210 (e.g., more similar to a camera being held in the physical world). The movie recorder 230 is orientated 233 and positioned 231 such that a virtual world object 304 is being viewed through the camera 240 (i.e., the object 304 would be part of an image or scene captured when recording is activated by a user). FIG. 3 shows that the viewfinder 310 is configured to fill (in this embodiment) the rear surface 236 of the movie recorder 230, and the viewfinder 310 is used by the movie recorder module/software to display to a user the images or portion of the scene 214 that would be captured during recording of a still image or video. In this case, this includes the sky features 312 as well as virtual world object 304 shown as element 314 in viewfinder 310. Again, this is achieved by using the data stored in the texture render buffer each time the render manager acts to render the virtual world and scene 214 to provide the displayed images in viewfinder 310.

The user may be allowed to provide input to operate the movie recorder 230 in the virtual world in a number of ways. In the illustrated embodiment, for example, a user is able to instruct the movie recorder module to record (or take) a snapshot by pressing a button 346 on the back of the camera 240 (e.g., a button with a particular color such as blue and/or with symbols indicating it should be used for capturing still images of the scene 214). Likewise, a user is able to instruct or command the movie recorder module or software to start and stop recording of moving images (or a movie/video) by choosing a different button 348, which may also be colored (e.g., a different color than button 346 such as red) and/or include symbols indicating it is the control button 348 for recording. Upon selection of these buttons 346, 348, the movie recorder module acts as discussed above with reference to FIG. 1 (and in the overview) to store data from the texture render buffer and then when the movie recording button 348 is pressed a second time to combine the stored images and also audio to generate a movie that may be stored as a separate movie file associated with the movie recorder 230 and/or with the particular user and/or virtual world in client device memory or another data storage device.

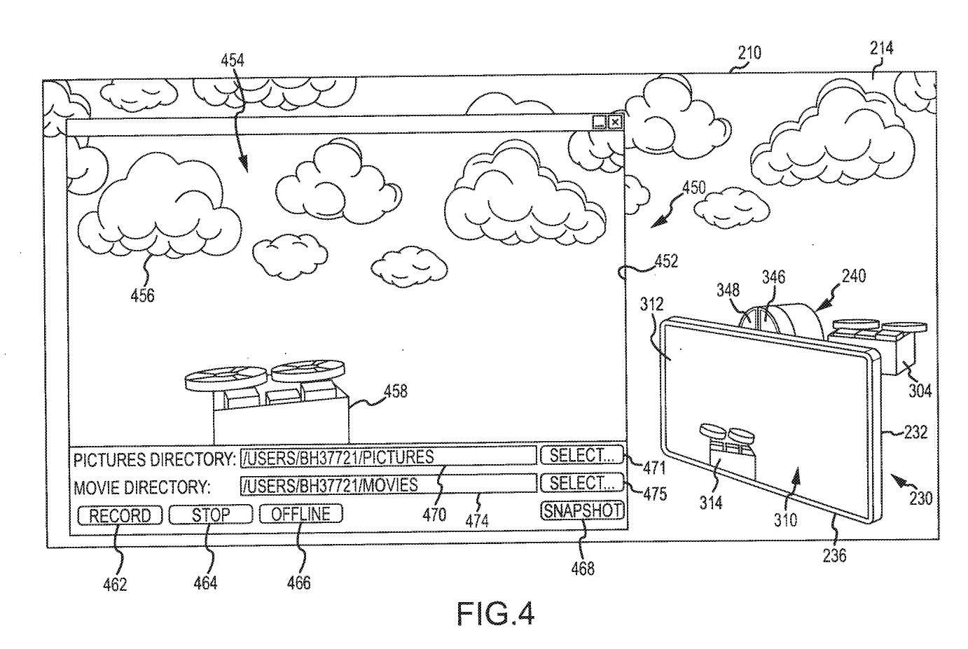

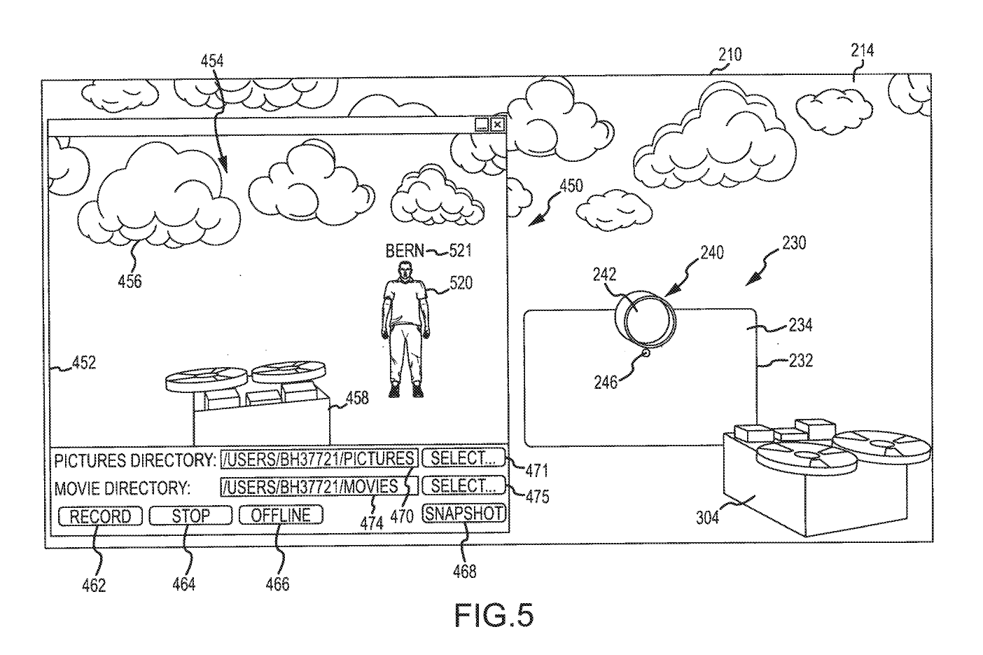

As discussed above, the user is able to have their own avatar present (facing the camera or moving about independently from the camera) in a recording, and, to achieve such recording, it may be easier for the user to operate the movie recorder using controls provided in a HUD. An exemplary HUD 450 is shown in the display 210 of FIG. 4. The HUD 450 may be generated by the movie recorder module (or other software) in response to a user selecting a camera in the virtual world (e.g., right clicking on a particular camera) and then requesting a HUD (e.g., selecting an “Open HUD Control Panel” selection from a displayed context menu (not shown in FIG. 4)). With the HUD 450 displayed in the scene 214 of the virtual world along with the movie recorder 3D object 230, the user can move their avatar 220 in front of the camera 240 as shown at 520 in FIG. 5 while continuing to be able to see what is being captured (both in the viewfinder 310 and the display window 452 of the HUD 450).

FIG. 4 provides a view of the movie recorder 230 from the rear and also shows inclusion of a HUD 450 in the VW display or window 210. The HUD 450 may be configured in a number of ways and is not limited to the design shown. However, in this embodiment, the HUD 450 includes a display window 452 that is used to display a VW image 454 that is the same image as shown in the viewfinder 310 as can be seen with VW features 456 and the VW object 458 in image 454 of display 452 that correspond with features 312 and object 314 in the viewfinder 310 of movie recorder 230. This particularly useful when the movie recorder 230 is orientated such that it is difficult or impossible to see the viewfinder 310 such as when the movie recorder 230 is positioned with its front surface 234 facing outward in the display 210 (e.g., as shown in FIG. 5) because the user is then still allowed to view in display 452 images 454 that are or would be recorded by the camera 240 of a particular movie recorder 230.

As shown, the HUD 450 provides a displayed image 454 in display window 452 that is a duplicate of that found in viewfinder 310. Also, the HUD 450 includes buttons/control components allowing a user to provide input to control operations of the movie recorder 230. In the illustrated example, the HUD 450 includes a button 462 to start recording and a button 464 to stop recording (e.g., a user may operate buttons 462, 464 to operate camera 240 rather than button 348). An operational status indicator 466 may also be provided indicating whether the camera 240 is recording or, as shown, not recording or offline. A control button 468 may also be provided for a user to take a snapshot or still picture of the image 454 presently shown in the display window 452. The HUD 450 may also include data entry boxes 470, 474 and selection buttons 471, 476 that allow a user to enter and/or select/set directories for storing pictures/still and/or movies (e.g., typically setting directories within the client computer/devices memory for storing these files such as movies in QuickTime format or the like).

FIG. 5 illustrates a view in display 210 of the virtual world 214 showing the movie recorder 230 orientated to face rearwards (or outwards from the VW) or toward a viewer of the world (e.g., outward from the monitor screen). In this position of the movie recorder 230, the camera 240 and lens 242 are visible to the user and can be seen targeting the object 304 in the VW scene 214, and the indicator 246 indicates that recording is not presently occurring. The HUD 450 is still being utilized by the user to operate the camera 230, which is particularly useful in this orientation as the buttons of camera 240 may be hidden from view when the recorder 230 is facing rearwards or outwards. In other words, the HUD 450 displays at 454 a duplicate of the viewfinder image(s) even when the viewfinder of the recorder 230 is not visible in the computer window 210. The user may have their avatar 220 positioned behind the VW object 304 in the scene 214 such that when the movie recorder 230 is rotated rearwards (e.g., pivoted about 180 degrees or the like) the user's avatar 220 is captured by the camera 240 (e.g., rendering of the avatar 220 is stored in the texture render buffer associated with the movie recorder in the media recording system).

As shown in FIG. 5, the displayed image 454 (e.g., image that is in or passed to texture render buffer and to viewfinder of recorder 230) includes the VW object 304 but also items/objects in the VW scene 214 that are viewed by the camera 240 and its lens 242. This includes the user's avatar 520 in this example with his label 521. In this manner, a user may position their avatar 520 within a captured scene 454 for recording in movies and stills. Also, the avatar 520 may be positioned so as to be facing the camera 240 to capture the face or front of the avatar 520 rather than just the back portion. Further, the movie recorder 230 may be moved independently of the avatar 520 (and vice versa). For example, the movie recorder 230 may be positioned as shown, and then the avatar 520 may be moved about the scene 214 without the movie recorder 230 being repositioned in response. In this way, the avatar 520 may be part of a movie that is generated and/or the avatar 520 may be moved in the scene 214 such that it is no longer visible by the camera 240 (or its lens 242) and is not shown in image 454.

During use of a movie recorder in a virtual world, as described above, a user may take a snapshot or still image once they have positioned a movie recorder within the world such as by using standard affordance tools (e.g., tools accessible via an Edit item in a context menu). To take a snapshot, the user may simply click on a still image button. The image may be stored as a JPEG file or other format file on the local hard drive. The name of the file may be “Virtual World Name_” appended with a timestamp, and its location may depend on the user's computer platform or OS platform (e.g., My Pictures for Windows, Pictures for Macintosh, My Documents for Linux, and/or user's home directory).

To take a movie, the user may instead click a movie record button (or control component) to start recording and then push the button again to stop recording (or select another button provided to stop recording). Auditory cues may be provided such as a “flash” noise to indicate a still image was captured, a beep to indicate recording started, and two beeps to indicate recording stopped, and so on. A notification message may also be presented in the virtual world window when a movie has been properly saved such as a QuickTime MOV file or other movie format file (after recording was stopped and the movie was generated and then stored on local hard drive or the like). The name of the movie file may be “Virtual World Name_” appended with a timestamp (and/or indication of a location in the world to identify the scene), and the file location default may again depend on the user's computer OS platform (e.g., My Videos for Windows, Movies for Macintosh, My Documents for Linux, and/or the user's home directory for other platforms).

For some advanced features of a media recording method/system, the user may open a Heads Up Display (HUD) for the movie recorder (e.g., via a context menu item labeled “Open HUD Control Panel” or the like). The HUD may provide a way of taking snapshot or recording a movie of the user's avatar. The HUD also may allow the user to change the location to which snapshots will be saved (e.g., by clicking on a select button adjacent a pictures directory text field). The user may also use the HUD to change the location to which movies are saved. The user may use the HUD to take a snapshot and/or to start and stop recording a movie.

The above examples in FIGS. 2-5 illustrate use of a single movie recorder in a virtual world and how this recorder may be positioned independently from a user's avatar. A user may readily utilize more than one movie recorder in a virtual world to capture the same scene from different angles/orientations and/or different positions. These two or more movie recorders may be operated concurrently or separately (e.g., one used to take stills and the other to take movies (also, note, of course, each recorder may be used/operated to take still images while concurrently recording a movie), one continuously running/recording and one that is selectively operated to record, both running/recording on an ongoing basis, and so on). In other cases, a user may position a movie recorder in one location and operate it to record a scene in a virtual world, and, while this first movie recorder is recording, leave this area of the virtual world. In a second scene, the user may then insert and position a second (or third, fourth, etc) movie recorder to take still or video images from the second scene (as well as audio in some cases). In this manner, the user may record two or more scenes of a virtual world concurrently. The user, for example, may record a class or meeting that they cannot attend and also record a class or meeting that they are attending in (or even presenting within with their avatar positioned in front of and facing the camera or moving about in front of the camera without affecting the position of the movie recorder).

As described, the media recording method provides a number of advantages over existing recording techniques for virtual worlds that have typically been limited to screen grabbing-type mechanisms. A user is able to put one or more movie recorders in a virtual world that they are participating in (e.g., that is running on their client device or computer), and they can selectively position these recorders and initiate recording. Frames are rendered (e.g., 20 frames per second or the like to create effective or non-flickering movies), and the rendered frames are shown in the viewfinder of the recorder (when the rear of the recorder is facing outward or the camera is facing forward into the VW) and simultaneously shown in the display window of the HUD (when the HUD is displayed in the VW window). The rendered images are also stored in a file that is uniquely named. Similarly, audio (e.g., a voice bridge that represents what audio is broadcast into the real world from the virtual world or the like) is recorded to a uniquely named file during movie recording. A stop recording button may be selected by the user, and the movie recorder module responds by generating the movie from the previously stored image and audio files.

Note, the above description highlights implementations in which a JPEG per frame is saved and then used to create a motion JPEG from these images (combined with audio data) when the user stops recording. In other implementations, though, the recording method involves creating a temporary motion JPEG dynamically while recording (concurrently created during recording). When the user stops recording, the audio can then be combined with this temporary motion JPEG to produce a final audio-enable motion JPEG. Hence, as far as a user is concerned, the resulting movie is the same.

In some embodiments, a user may instead or concurrently cause the images and audio to be webcast or streamed to a separate client (e.g., over the Internet to another of the user's computing devices such as a wireless phone, netbook, or the like). The user may later use nearly any video player to play the stored movie. The user may also use post-processing tools to process the movie (e.g., edit the movie to create a derivative work, change the coloring or lighting (e.g., make a black and white version of a color movie), and so on). For example, post-processing (or concurrent processing) may be used to add or inject additional data or media into the recording images or into the movie. In one embodiment, text is added to a movie such as to provide information on the attendees, the location in the VW, the time of a recorded scene, information on attendees, and so on while. In some implementations subtitles are added such as to present the audio in a different language.

In some embodiments, each movie recorder is also associated with a security level or rating that is used by the movie recorder module or software to decide whether the user has access or is allowed by the administrators of the virtual world to record the images (and/or sound) from a scene in a virtual world. For example, a user may be granted access to a VW scene (such as a business meeting or educational seminar) as an attendee but not as a person allowed to make movies/recordings. In such a situation, an attendee-only security level may be assigned to the user (or their movie recorder) such that the movie recorder module will not operate in a record mode to store image/sound files to their hard drive for a particular scene (or for an entire virtual world in some cases). Another user may be assigned full access rights to the scene, and their movie recorder may be operated in the record mode for the same scene to allow them to create movies of the scene (e.g., to create an instructional movie from the training session for later distribution/use or the like). The first user though may have full access rights to another scene within the virtual world, which would allow them to record images/sound of that scene or portion of the virtual world. In this way, a user can be granted selective recording rights within a virtual world (e.g., provide a security system for the virtual world. One camera or movie recorder may be thought of a secure camera and the other may be thought of as an insecure camera, and the movie recorder 3D object may be generated or rendered so as to provide which type of camera a user has (or to show the record mode of operation is blocked or allowed based on the security settings and the current location of the movie recorder).

In many situations, the movie recorders are located at 3D location within the VW, orientated with a particular focus direction, and then fixed in this position during recording. However, in some embodiments, the movie recorders may be automatically moved during recording by scripts or programs run by or called by movie recorder module. For example, the movie recorder may be positioned upon a virtual boom, and the boom may be moved similar to a physical world camera to record differing parts of a scene or a scene from differing angles/orientations. In one example of such an automatically moving movie recorder, the movie recorder is programmed to follow the user's avatar so as to keep it in a recorded frame (e.g., pan about a scene in a VW to follow the avatar). In another example, the movie recorder is operated such that the camera acts to capture images of each avatar that is speaking in the virtual world and/or to zoom in on an avatar that is speaking or performing other acts in the world (e.g., two movie recorders may be provided to record a scene in a VW with one recording the overall scene or a wide angle view and one recording close ups of a panel or presenters (or ones of the presenters that are actively presenting) or close ups of a white board or other object significant for the scene).

Embodiments of the subject matter described in this specification can be implemented as one or more computer program products, i.e., one or more modules of computer program instructions encoded on a computer-readable medium for execution by, or to control the operation of, a data processing apparatus. For example, the modules used to provide the VW generator 112, the MR module 114, the render manager 116, and the like may be provided in such computer-readable medium and executed by a processor(s) of the system 106 or the like. The computer-readable medium can be a machine-readable storage device, a machine-readable storage substrate, a memory device, a composition of matter affecting a machine-readable propagated signal, or a combination of one or more of them. The term computer system that uses/provides the update buffer queuing and garbage collection method/processes encompasses all apparatus, devices, and machines for processing data, including by way of example a programmable processor, a computer, or multiple processors or computers. The system (such as system 106 of FIG. 1) can include, in addition to hardware, code that creates an execution environment for the computer program in question.

A computer program (also known as a program, software, software application, script, or code) used to provide the functionality described herein (such as to provide a virtual world on a computer or client device that provides enhanced media recording with one or more independently positionable and operable movie recorders) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit). Processors suitable for the execution of a computer program include, by way of example, both general and special purpose microprocessors, and any one or more processors of any kind of digital computer. Generally, a processor will receive instructions and data from a read-only memory or a random access memory or both. Generally, the elements of a computer are a processor for performing instructions and one or more memory devices for storing instructions and data. The techniques described herein may be implemented by a computer system configured to provide the functionality described.

For example, FIG. 1 is a block diagram illustrating one embodiment of a computer system or network 100 configured to implement the methods described herein. In different embodiments, the client computer 106 may be or include any of various types of devices, including, but not limited to a personal computer system, desktop computer, laptop, notebook, or netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, or, in general, any type of computing or electronic device.

Typically, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, a digital camera, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry. To provide for interaction with a user (with an I/O portion of system 106 such as to provide the interface 190 or the like), embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and/or parallel processing may be advantageous. Moreover, the separation of various system components in the embodiments described above should not be understood as requiring such separation in all embodiments, and it should be understood that the described program components and systems can generally be integrated together in a single software and/or hardware product or packaged into multiple software and/or hardware products.

We claim:

1. A method of recording media in a virtual world, comprising:
operating a client computer to generate a virtual world in which a user participates via an avatar;
inserting a movie recorder into the virtual world, wherein the movie recorder has a three-dimensional (3D) location in the virtual world selectable by the user without reference to a location of the avatar;
with the client computer, receiving input from the user to record a scene of the virtual world with the movie recorder; and
in response to the user input, storing rendered images of the scene in data storage.

2. The method of claim 1, further comprising after the inserting, associating a texture render buffer in memory of the client computer with the movie recorder, rendering frames of the images of the scene, storing the rendered frames of the images in the texture render buffer, and transferring content from the texture render buffer to the data storage during the storing of the rendered images of the scene.

3. The method of claim 2, wherein the movie recorder comprises a 3D object displayed within the virtual world in a display window of the client computer and wherein the movie recorder 3D object includes a body with a front and rear surface, the rear surface including a viewfinder displaying the rendered frames in the texture render buffer to display the scene of the virtual world.

4. The method of claim 3, further comprising resetting the 3D location of the movie recorder or the location of the avatar such that the avatar is positioned in the scene with the avatar facing the front surface of the body and wherein the front surface comprises a camera defining a view of the scene of the virtual world for use in recording the scene.

5. The method of claim 3, further operating the client computer to generate a heads up display and displaying the heads up display in display window of the virtual world, wherein the heads up display includes a display portion displaying the rendered frames in the texture render buffer concurrently with the display in the viewfinder.

6. The method of claim 5, wherein the display portion of the heads up display displays the rendered frames when the movie recorder is oriented by the user such that the front surface of the body is displayed in the display window of the virtual world.

7. The method of claim 1, wherein the 3D location of the movie recorder is maintained and the location of the avatar is altered based on input from the user.

8. The method of claim 1, further comprising inserting a second movie recorder into the virtual world, wherein the second movie recorder has an associated texture render buffer provided in memory storing frames of a scene of the virtual world viewable from a camera on the second movie recorder, and wherein the second movie recorder has a 3D location in the virtual world that is selectable based on user input independent of the 3D location of the movie recorder and the location of the avatar.

9. The method of claim 8, wherein the scene of the virtual world viewable from the camera of the second movie recorder differs from the scene recorded by the movie recorder and wherein the receiving and storing steps are performed separately for the second movie recorder.

10. The method of claim 1, further comprising storing audio data associated with the scene in the data storage concurrently with the storing of the rendered images, receiving instructions to stop the recording of the scene, and generating a movie file comprising combining the stored rendered images and the stored audio data.

11. A computer system adapted for providing a virtual world to a user, comprising:
a monitor;
a processor;
a virtual world generator run by the processor to generate a virtual world and display the virtual world in a window on the monitor;
a movie recorder module operable by the processor to respond to input received from the user by inserting a movie recorder, with a camera defining a viewable scene within the virtual world, at a position and with an orientation of the camera both set by the user input;
memory including a texture render buffer associated with the movie recorder, the texture render buffer storing frames of images of the viewable scene of the virtual world; and
data storage storing at least one of the frames of the images in a file associated with the movie recorder in response to an instruction to record being received from the user.

12. The system of claim 11, wherein the stored image is a snapshot of the viewable scene.

13. The system of claim 11, wherein the data storage further stores audio data local to the movie recorder in the virtual world and wherein the movie recorder module operates in response to a stop record command to combine the stored frames of the images and the stored local audio data to generate a movie of the viewable scene of the virtual world.

14. The system of claim 11, wherein the virtual world includes an avatar associated with the user and wherein the position of the movie recorder and the orientation of the camera are both independent relative to a position of the avatar.

15. The system of claim 11, wherein the movie recorder includes a viewfinder on a side of the movie recorder opposite the camera and wherein the viewfinder displays the frames of the images stored in the texture render buffer.

16. A media recording method for a virtual world, comprising:
with a processor, running a movie recorder module to insert a first movie recorder and a second movie recorder in the virtual world, wherein the first and second movie recorders are located at first and second positions within the virtual world that are independently selectable by a participant of the virtual world;
associating a texture render buffer with each of the first and second movie recorders;
with the processor, running a render manager to render frames of the virtual world; and
storing a first set of rendered frames associated with a scene of the virtual world viewable by the first movie recorder in the texture render buffer associated with the first movie recorder and storing a second set of rendered frames associated with a scene of the virtual world viewable by the second movie recorder in the texture render buffer associated with the second movie recorder.

17. The method of claim 16, wherein the first and second positions are set independent of a position of an avatar linked to the participant and further comprising in response to user input initiating recording of the virtual world, transferring the first and second sets of rendered frames to first and second data files and, when recording is stopped, generating a first movie by combining images in the first data file and a second movie by combining images in the second data file.

18. The method of claim 17, wherein the position of the avatar is selected such that the scene of the virtual world viewable by the first movie recorder includes the avatar and wherein the avatar is facing toward the movie recorder.

19. The method of claim 16, further comprising streaming the first set of rendered frames from the texture render buffer associated with the first movie recorder over a digital communications network to a remote client device.

20. The method of claim 16, further comprising providing a heads up display in the virtual world for the first movie recorder and wherein the heads up display includes a display section displaying the first set of rendered frames and a movie recorder control section including controls for initiating recording of content of the texture render buffer for the first movie recorder as still images or as movies.
